(19) United States
(12) Patent Application Publication
(10) Pub. No.: US 2025/0135575 A1
(43) Pub. Date: May 1, 2025

(54) LASER DEVICE AND ITS USE AND METHOD FOR PROCESSING A GLASS SHEET

(71) Applicant: HEGLA boraident GmbH & Co. KG, Beverungen (DE)

(72) Inventors: Bernhard Hötger, Lauenförde (DE); Thomas Rainer, Wernigerode OT Minsleben (DE)

(21) Appl. No.: 18/722,724

(22) PCT Filed: Nov. 9, 2022
(86) PCT No.: PCT/EP2022/081267

§ 371 Date: Jun. 21, 2024

(30) Foreign Application Priority Data
Dec. 23, 2021 (DE) 10 2021 215 023.3

(51) Int. Cl. B23K 26/00; B23K 26/03; B23K 26/046; B23K 26/08; B23K 26/082; B23K 26/70; B23K 103/00

(52) U.S. Cl. CPC B23K 26/0096; B23K 26/032; B23K 26/046; B23K 26/082; B23K 26/0884; B23K 26/705; B23K 26/706; B23K 2103/54

(57) ABSTRACT

A mobile laser device for processing glass sheets installed in an object, preferably in a vehicle, preferably in a train, or in a structure work, preferably in a building, and the use of the laser device and a method for processing a glass sheet.

### CROSS REFERENCE TO RELATED APPLICATIONS

This application is a 35 U.S.C. § 371 national phase application of International Application No.: PCT/EP2022/081267, filed Nov. 9, 2022, which claims the benefit of priority under 35 U.S.C. § 119 to German Patent Application No.: 10 2021 215 023.3, filed Dec. 23, 2021, the contents of which are incorporated herein by reference in their entirety.

### FIELD

The present invention relates to a mobile laser device for processing glass sheets installed in an object, preferably a vehicle, more preferably a train, or a structure work, preferably a building. In addition, the invention relates to the use of the laser device and a method for processing a glass sheet.

### BACKGROUND

The statements in this section merely provide background information related to the present disclosure and several definitions for terms used in the present disclosure and may not constitute prior art.

Flat glass is any glass in the form of panes or sheets, regardless of the production method used.

Glass sheets can consist of a single glass pane or glass plate (single-pane glass) or they can be laminated glass. The term laminated glass sheet generally refers to a glass sheet consisting of two or more glass panes or glass plates with the same or different thicknesses, whereby the glass panes are joined together by an intermediate layer of plastic.

In order to provide flat glass sheets with filter, mirror, heating or other functions, a wide variety of single or multi-layer functional coatings are applied to the glass panes. The functions can be thermal protection, solar protection or heating, for example. In the case of Low-E glass (Low-E=low emissivity=low heat radiation), one or more metal layers reduce the emissivity of the glass panes and serve as a heat and/or solar protection layer.

In general, the function coating or functional coating is a single functional layer or a layer structure with several functional layers with a total thickness of <2 μm. The layer structure is usually obtained by deposition processes, preferably sputtering.

The individual functional layers are therefore generally metallic and/or ceramic layers. For example, they are metallic low-emission layers or electrical heating layers. One or more dielectric (functional) layers, e.g. made of an oxide such as aluminum oxide, can be arranged between the individual metallic functional layers of a functional coating. In addition, a bonding layer of tin oxide is usually present between the functional coating and the glass surface.

Special laminated glass sheets have, for example, a first, in particular inner, glass pane consisting of a usually uncoated glass pane and a second, in particular outer, coated glass pane, in particular with a thermal protection layer.

Window panes of trains also usually have this type of heat-insulating functional coating. The problem here is that although the functional coating saves energy, the mobile phone connection suffers as a result. This is because the metallic functional coating creates a Faraday cage that shields the interior of the train from electromagnetic waves. As a result, ETH Zurich has developed a new window glass in which the functional coating is modified so that it is more permeable to electromagnetic mobile phone waves and light (www.20min.ch_wissen_news_story_ETH-Superglas-macht-Handy.pdf). The Faraday cage is interrupted by processing the metallic functional layer with a laser. By use of a laser, a structure is engraved into the metallic functional layer, whereby approx. 2.5% of the surface is removed.

U.S. Pat. No. 8,927,069 B1 also discloses such a method and a device for processing a low-E layer of a glass sheet by laser ablation. The mobile device can also be used for processing already installed glass sheets of an insulating glazing.

Furthermore, laser marking methods and devices for marking glass sheets are known from the two publications DE 10 2005 026 038 A1 and DE 10 2005 025 982 A1.

According to DE 10 2005 026 038 A1, a glass-like layer with metal nanoparticles is applied to the surface of the glass pane by a laser. For this purpose, a dispenser or carrier medium is brought into contact with the glass pane surface to be labelled and a marking is created on the glass pane surface by laser beam-induced processes.

According to DE 10 2011 085 714 A1, a similar process is used to produce an electrical contact on the surface of an object.

According to DE 10 2005 025 982 A1, the Low-E functional coating of a glass pane is changed in color by laser beam irradiation in such a way that a marking is created.

DE 10 2018 217 970 A1 discloses a method and a device for producing an electronic structure on a glass pane, which has a functional coating with at least one electrically conductive functional layer on at least one of its two glass pane surfaces, wherein the functional coating is structured by means of laser radiation in such a way that the electronic structure is produced. The laser structuring is carried out by modifying or ablating the functional coating.

It is also known in the field to provide the glass sheets with an internal marking, which is located inside the glass sheets. The internal marking can for example be laser-induced (Forschungsvereinigung Feinmechanik, Optik und Medizintechnik e.V., “Untersuchung zur Materialreaktion im Innern optisch transparenter Materialien nach Ultrakurz-Laserpulsanregung: Generierung spannungsarmer Innenmarkierungen (micro-dots)).

For example, it is known to create laser-induced microcracks in glass. The structures created scatter the light and are thus recognizable as markings and can be read with code readers.

Laser-induced generation of color centers (volume coloring) in the glass for internal marking is also known. The internal marking of glass sheets due to the formation of color centers is based on the fact that defects are created in the SiO₂ network by the laser radiation. The defects lead to a change in the optical properties, in particular to a decrease in optical transmission.

Internal labelling can also be achieved by generating micro-dots, which is based on the local change in the complex refractive index (=optical density). The density change is generated by localized melting of the material, i.e. a thermal process.

Furthermore, DE 10 2014 002 644 A1 discloses the creation of a bird protection structure on a glass sheet surface by laser transfer printing.

### SUMMARY

An objective of the present disclosure is to provide a mobile laser device for processing built-in glass sheets, which can be used flexibly for different processing methods and ensures a high processing quality.

Further objectives of the present disclosure include the provision of a processing method and a use of the laser device, which also guarantee high processing quality.

This objective of the present disclosure is solved by a mobile laser device with the following features. This mobile laser device is generally used for processing glass sheets, installed in an object, preferably a vehicle, more preferably a train, or a structure work, preferably a building, and comprising at least one glass pane, by means of laser radiation at different places of use, having a laser gantry. This laser gantry includes (a) a gantry base frame, (b) a laser unit movable back and forth on the gantry base frame in an x, y and z direction of the laser gantry relative to the gantry base frame, having a laser head with a, preferably interchangeable, laser radiation source for providing a laser beam, (c) preferably a laser protection bonnet covering the laser unit to protect the environment from laser radiation, and (d) fastening means for fixed but detachable attachment of the laser gantry to the object. This laser unit comprises a distance measuring device for measuring the glass sheet to be processed in the z-direction, and the laser head comprises an optical z-focus adjustment device for the, preferably automated, displacement of a laser focus of the laser beam along an optical z-axis of the laser head, in particular during the processing of the glass sheet.

The objective of the present disclosure is further solved by a use of this mobile laser device for processing a glass sheet having at least one glass pane and installed in an object, preferably in a structure work, more preferably in a building, or in a vehicle, preferably in a train, by means of laser radiation.

The objective of the present disclosure is further solved by a method for processing a glass sheet having at least one glass pane and being installed in an object, preferably in a structure work, more preferably in a building, or in a vehicle, preferably in a train, by means of laser radiation, characterized in that processing is carried out by means of the mobile laser device.

Advantageous further embodiments of the present disclosure will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a perspective view of the laser device according to the present disclosure without a laser safety device;

FIG. 2 is a rear view of the laser device according to the present disclosure without laser safety device;

FIG. 3 is a side view of the laser device according to the present disclosure without laser safety device;

FIG. 4 is another side view of the laser device according to the present disclosure without laser safety device with tilted laser gantry;

FIG. 5 is a perspective view of the laser device according to the present disclosure in disassembled form without a laser safety device;

FIG. 6 is a side view of the laser device according to the present disclosure in disassembled form without laser safety device;

FIG. 7 is a perspective view of the laser gantry of the laser device according to the present disclosure;

FIG. 8 is a further perspective view of the laser gantry of the laser device according to the present disclosure;

FIG. 9 is a perspective view of the laser device according to the present disclosure attached to a train;

FIG. 10 is a further perspective view of the laser device according to the present disclosure attached to a train;

FIG. 11 is a highly simplified and schematically a laser head of the laser device according to the present disclosure during laser ablation;

FIG. 12 is a highly simplified and schematically a laser head of the laser device according to the present disclosure during laser modification;

FIG. 13 is a highly simplified and schematically a laser head of the laser device according to the present disclosure when lasing a plastic intermediate layer; and

FIG. 14 is a highly simplified and schematically a laser head of the laser device according to the present disclosure during laser transfer printing.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

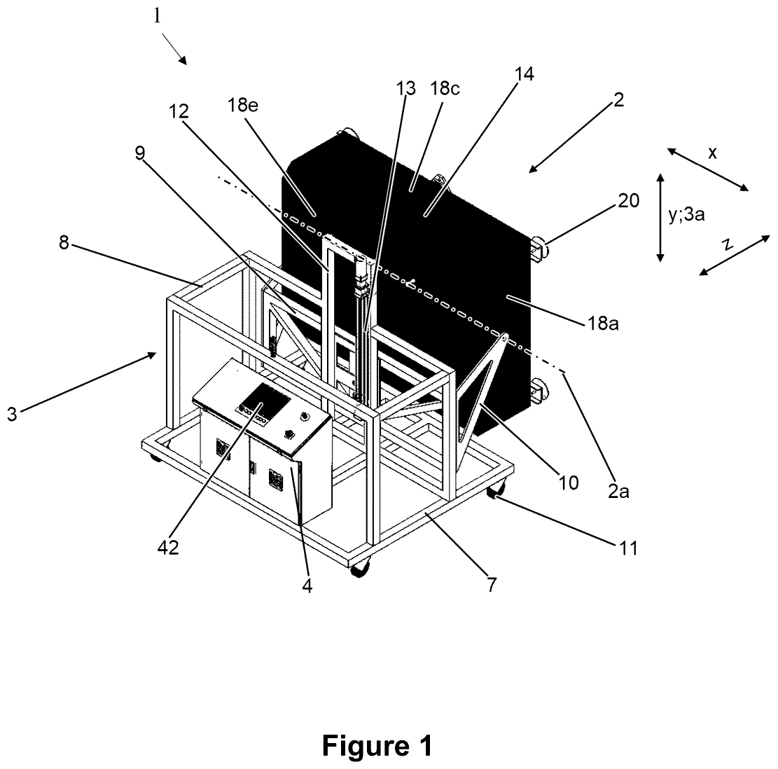

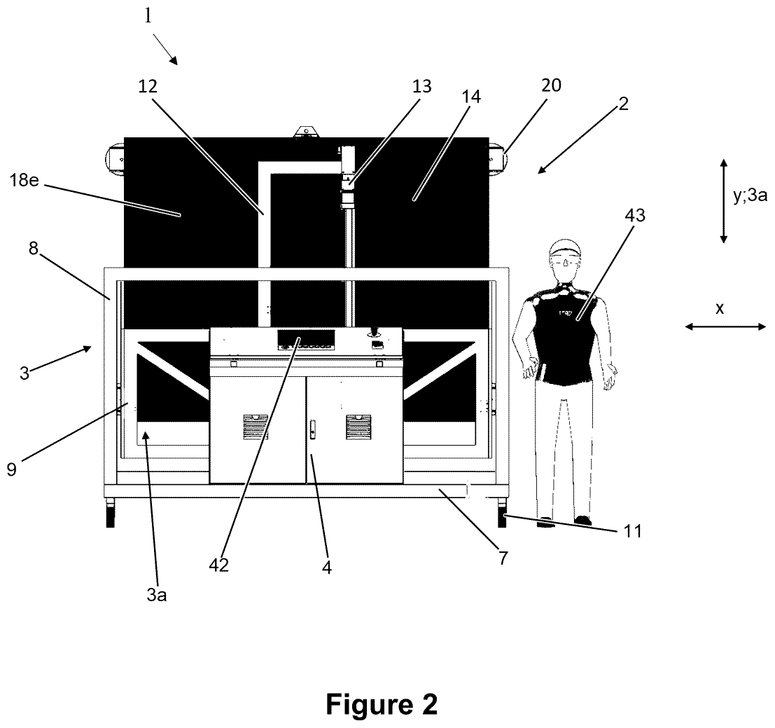

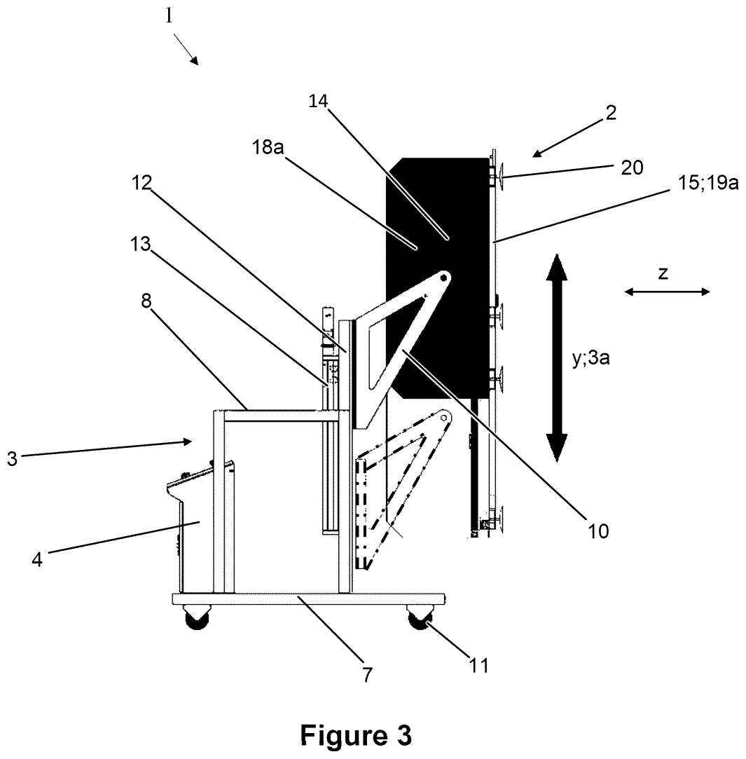

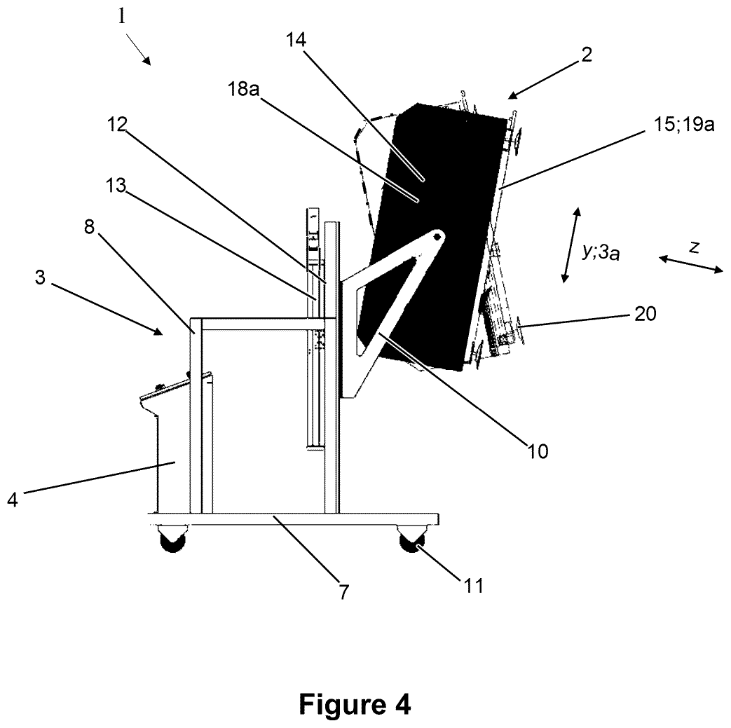

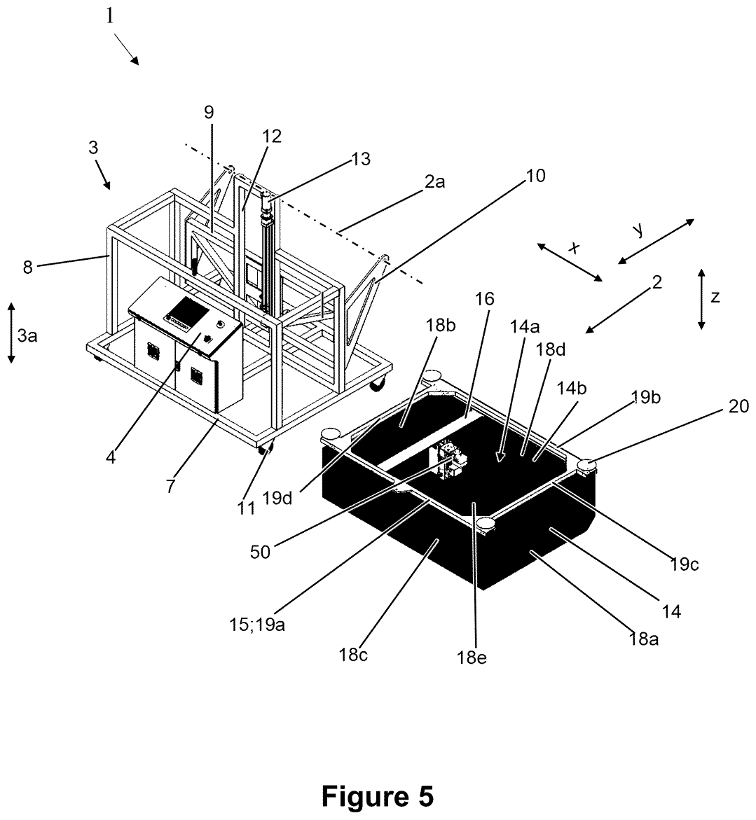

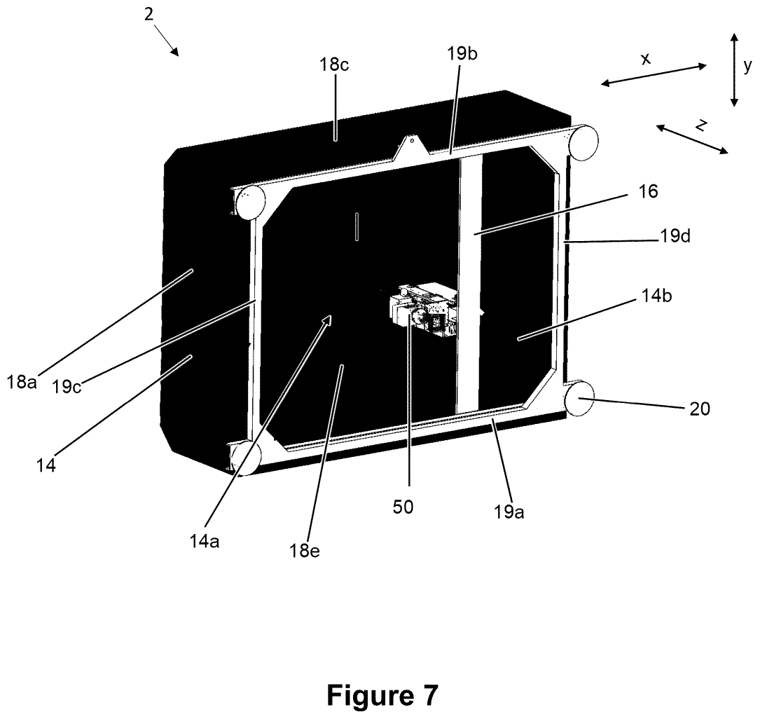

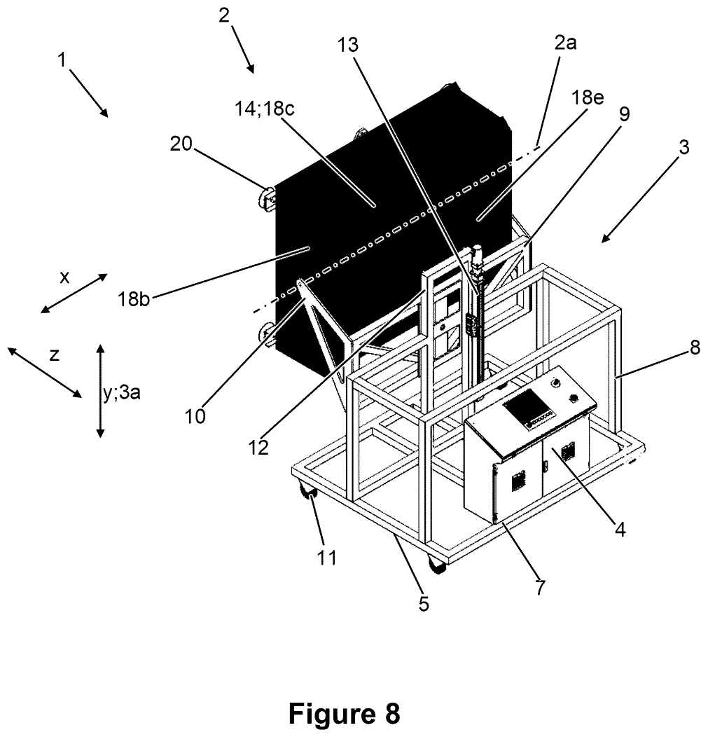

Referring to FIGS. 1 to 10, the mobile laser device 1 generally comprises a laser gantry 2, preferably a transport and positioning rack 3, a control device 4 and preferably a laser safety device 5.

Mobile means that the laser device 1 is not fixed or stationary. It can therefore be used at different locations.

The transport and positioning rack 3 is used to set up and preferably move the mobile laser device 1 on the underground. As a result, the transport and positioning rack 3 is also used to position the laser device 1 and, in particular, the laser gantry 2 attached to it relative to a glass sheet 6 to be processed.

The transport and positioning rack 3 preferably has an, in particular quadratic, base frame 7, an, in particular cuboid, bearing frame 8, and an, in particular quadratic, gantry fastening frame 9, as well as two gantry fastening arms 10.

The base frame 7 serves to support the laser device 1 on the underground. Preferably, it also has transport rollers 11 on the underside so that the laser device 1 can be moved on the underground.

The bearing frame 8 serves to support the laser gantry 2 and has a guide element 12 for this purpose. The gantry fastening frame 9 is mounted on the guide element 12 so that it can be moved back and forth in an, in particular vertical, rack height direction 3a. The base frame 7 also preferably has drive means 13, for example a drive motor and a gear drive, with which the gantry fastening frame 9 is connected so as to be drivable back and forth in the rack height direction 3a.

This means that the laser gantry 2 is mounted on the bearing frame 8 so that it can be moved back and forth, in particular in the vertical rack height direction 3a.

However, the laser gantry 2 can also be positioned manually in the rack height direction 3a, e.g. using a pulley mechanism.

The gantry fastening arms 10 are attached at one end to the gantry fastening frame 9. The laser gantry 2 is attached at the other end respectively. Preferably, the laser gantry 2 is mounted on the gantry fastening arms 10 so that it can rotate about a, preferably horizontal, laser gantry rotation axis 2a. The laser gantry 2 can be freely rotatable or rotatably driven, for example driven by an electric motor. In particular, if it is freely rotatable, locking means are preferably provided for locking the laser gantry 2 in the desired position.

The laser gantry 2 comprises a laser protection bonnet 14, an, in particular quadratic, gantry base frame 15a guide rail 16 attached to it and a laser unit 50 mounted on the guide rail with a laser head 17 and a distance measuring device 49 for measuring the glass sheet 6 to be processed in the z-direction.

The laser gantry 2 also comprises an x-direction, a y-direction and a z-direction.

The laser gantry rotational axis 2a is preferably parallel to the x-direction.

The laser protection bonnet 14 preferably comprises two bonnet side walls 18a;b opposite to one another in the x-direction, a lower bonnet circumferential wall 18c and an upper bonnet circumferential wall 18d as well as a bonnet base wall 18e.

The laser protection bonnet 14 comprises a bonnet interior space 14a and a bonnet opening 14b. The bonnet side walls 18a;b, the lower bonnet circumferential wall 18c and the upper bonnet circumferential wall 18d as well as the bonnet base wall 18e surround the bonnet interior space 14a.

The laser protection bonnet 14 serves to protect the surroundings from laser radiation.

Furthermore, the laser safety bonnet 14 is made of a laser-resistant material, preferably sheet steel.

The gantry base frame 15 comprises two guide beams 19a;b that are parallel to and spaced apart from each other and extend in the x-direction, as well as two cross beams 19c;d that are also parallel to each other and perpendicular to the guide beams 19a;b. The cross beams 19c;d thus extend in the y-direction. In addition, the gantry base frame 15 has an frame inner side facing the laser protection bonnet 14 and an frame outer side facing away from it.

The laser protection bonnet 14 is also attached to the gantry base frame 15 and extends away from it, in particular from frame inner side. The gantry base frame 15 is thus located at an open end of the laser protection bonnet 14. It surrounds a bonnet opening 14b of the laser protection bonnet 14.

In addition, the gantry base frame 15 comprises fastening means for fastening the laser device 1 to the object or component to be processed. The fastening means are used for fixed, i.e. non-displaceable and non-rotatable, but detachable fastening to the object or component to be processed. Preferably, the gantry base frame 15 comprises several, preferably four, suction cups 20, preferably vacuum suction cups. The suction cups 20 are preferably attached to the frame outer side and extend away from it. In addition, one suction cup 20 is preferably arranged in a corner area of the gantry base frame 15.

The guide rail 16 extending in the y-direction has an rail inner side 16a facing the laser protection bonnet 14 and an rail outer side 16b facing away from it. In addition, the guide rail 16 is mounted on the two guide beams 19a;b so that it can be moved back and forth in the x-direction. The guide rail 16 thus extends from one guide beam 19a to the opposite guide beam 19b. Furthermore, the laser gantry 2 has drive means for driving the guide rail 16 in the x-direction. The guide rail 16 is therefore connected to the drive means so as to be drivable back and forth in the x-direction. Preferably, the drive means is a linear drive, preferably electromotive.

The laser unit 50 is mounted on the guide rail 16 so that it can move back and forth in the y-direction. It is also arranged adjacent to the rail inner side 16a. The laser unit 50 is thus arranged in the bonnet interior space 14a. Furthermore, the laser gantry 2 comprises drive means for driving the laser unit 50 in the y-direction. The laser unit 50 is therefore connected to the drive means so as to be drivable back and forth in the y-direction relative to the guide rail 16. Preferably, the drive means is a linear drive, preferably electromotive, preferably a belt axis drive.

In addition, the laser unit 50 is preferably also mounted on the guide rail 16 so that it can be moved back and forth in the z-direction. For this purpose, the laser gantry 2 has drive means for driving the laser unit 50 in the z-direction. The laser unit 50 is therefore connected to the drive means so as to be drivable back and forth in the z-direction relative to the guide rail 16. Preferably, the drive means is a linear drive, preferably electromotive, in particular with a spindle axis.

The laser device 1 according to the present disclosure is also set up to alternatively perform different processes. At least the laser device 1 is set up to perform at least one, preferably at least two, of the following methods:
a) Laser ablation of a superficial glass pane coating 23 of a glass pane 22 of glass sheets 6;
b) Laser modification of a superficial glass pane coating 23 of a glass pane 22 of glass sheets 6;
c) Laser transfer printing;
d) Laser treatment of a plastic interlayer 24 of a laminated glass sheet 25;
e) Laser engraving of a glass pane surface 22a;b;
f) Producing an internal modification in glass sheets 6;
g) Producing an internal engraving in glass sheets 6;
h) Deleting the interior modification; and
i) Deleting the laser engraving of the glass pane surface 22a;b.

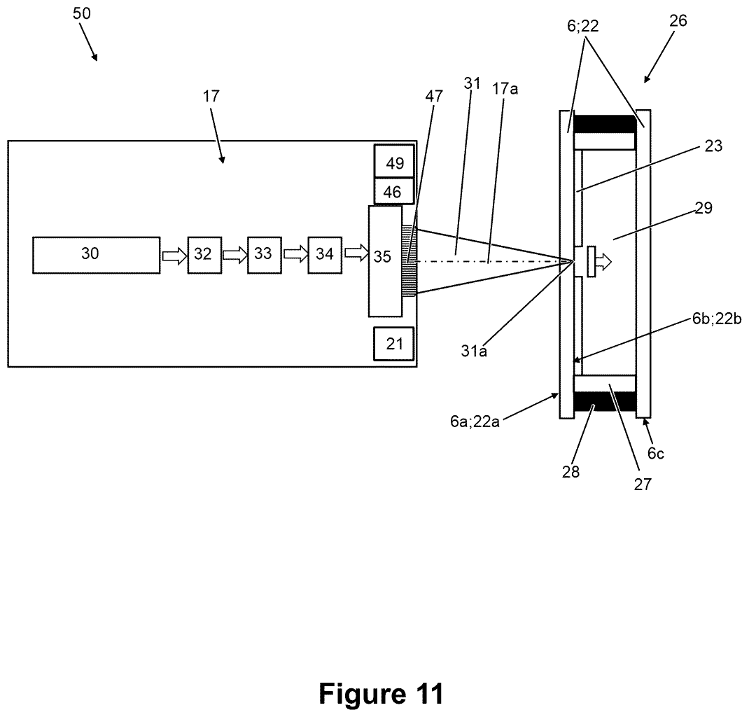

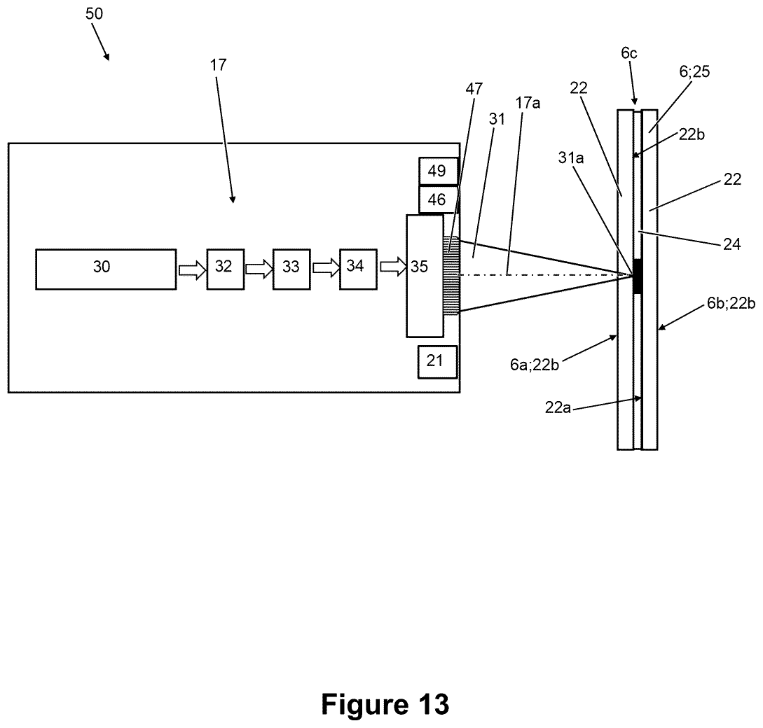

A glass sheet 6 to be processed (FIGS. 11-14) can consist of a single pane of glass or glass plate 22 (single-pane glass). Or it can be a laminated glass sheet 25. A laminated glass sheet 25 is understood to be a glass sheet 6 formed from two or more glass panes or glass sheets 22 of the same or different thicknesses, the glass panes 22 being joined together by an intermediate layer of plastic or a plastic film 24 (FIG. 13). The glass sheet 6 thus has one or more glass panes 22.

The glass sheet 6 also comprises two opposing, outer glass sheet surfaces 6a;b. The glass sheet surfaces 6a;b are parallel to the glass sheet plane and, during processing, preferably perpendicular to the z-direction. Furthermore, the glass sheet 3 has a circumferential glass sheet edge 6c, which in particular connects the two glass sheet surfaces 6a;b to one another.

A glass pane 22 also respectively comprises two opposing glass pane surfaces 22a;b. The glass pane surfaces 22a;b are also parallel to the glass sheet plane and, during processing, preferably perpendicular to the z-direction.

If the glass sheet 6 is designed as a single-pane glass sheet, the two glass pane surfaces 22a;b of the single glass pane 22 also form the glass sheet surfaces 6a;b of the glass sheet 6 (FIGS. 11, 12, 14).

If the glass sheet 6 is designed as a laminated glass sheet 25 (FIG. 13), the outer glass pane surfaces 22a;b form the glass sheet surfaces 6a;b of the glass sheet 6 and the other glass pane surfaces 22a;b are internal. The laminated glass sheet 25 thus has more than two, in particular four, glass pane surfaces 22a;b.

The glass sheet 6 is preferably flat. However, it can also be curved or domed. For example, it can be in the form of a cylinder shell. The glass sheet 6 is therefore a flat glass element.

Furthermore, the glass sheet 6 can have a superficial glass pane coating 23, preferably a functional coating, on at least one of its glass pane surfaces 22a;b. Functional coatings are known to provide glass sheets 6 with certain functions, e.g. filter, mirror and heating functions.

The glass pane coating 23, in particular the functional coating, can comprise one or more individual (functional) layers in a manner known per se. Several (functional) layers are thus a (functional) layer laminate. The functional layers change certain properties of the glass sheet 6 or give it certain functions. The functions can be, for example, thermal insulation, solar protection or heating. The functional coating is preferably a wavelength-selective coating or Low-E coating.

The glass pane coating 23, in particular the functional coating, of the glass sheet 6 preferably has at least one, preferably several, electrically conductive, metal-containing (functional) layers. In addition, the coating 23, in particular the functional coating, can have at least one electrically semi-conductive (functional) layer.

Preferably, the glass pane coating 23 has at least one metallic and/or at least one ceramic layer, preferably a metal oxide layer.

Preferably, the glass pane coating 23, in particular the functional coating, comprises a metal-containing, preferably a metallic (functional) layer, more preferably made of silver, copper or gold. A (functional) layer of metal oxide preferably consists of tin oxide. Of course, the ceramic (functional) layer does not have to consist of oxide ceramic. It can also be a non-oxide ceramic (functional) layer, for example.

The glass pane coating 23, in particular the functional coating, can also comprise at least one electrically insulating (functional) layer.

The glass pane coating 23, in particular the functional coating, of the glass sheet 6 thus preferably has at least one electrically conductive, metallic and/or at least one electrically conductive, preferably metal-containing, ceramic (functional) layer.

The (functional) layers can be applied to the glass sheet 6 by sputtering or wet chemistry.

According to a further preferred embodiment, the glass pane coating 23, preferably the functional coating, is a, preferably single-layered, pyrolytic coating. This consists of a metal oxide, preferably tin oxide.

The production of such a glass pane coating 23 is known. The coating material is present in vapor, liquid or solid form. The coating is formed during the manufacturing process of the glass sheet 6 by a reaction of the metal oxide coating material on the hot glass sheet surface 6a (hard coating process). Glass sheets 6 with this type of functional coating allow short-wave radiation to pass through and reflect long-wave infrared radiation.

Furthermore, the glass pane coating 23, preferably the functional coating, preferably has a thickness of <2 μm, preferably <1 μm.

The glass sheet 6 to be processed can also have a known outer superficial protective coating made of plastic, in particular in the form of a non-peelable polymer coating or a peelable plastic film. The protective coating covers the respective glass sheet surface 6a;b or, if present, the glass pane coating 23.

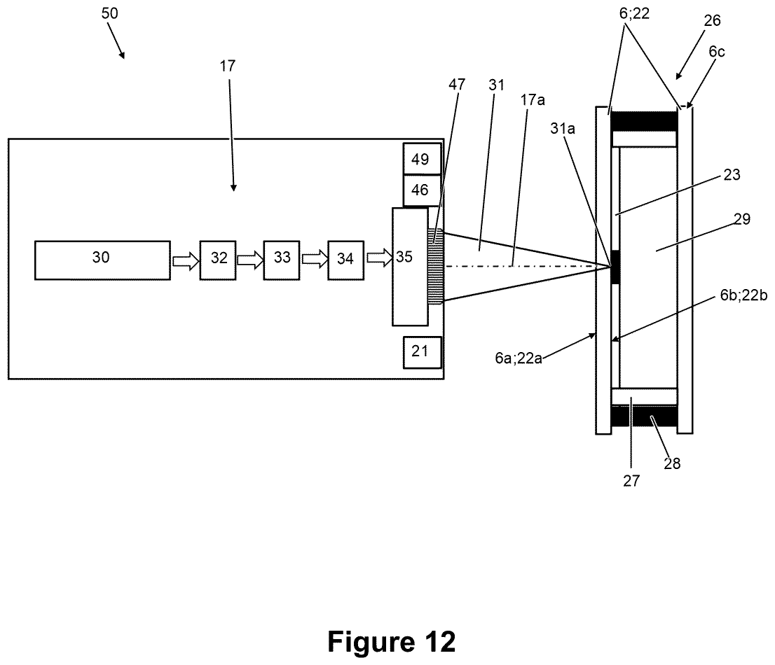

In addition, the glass sheet 6 to be processed can be part of an insulating glazing 26 (FIGS. 11, 12). The insulating glazing 26 comprises, in a manner known per se, at least two glass sheets 6 arranged parallel to and spaced apart from one another and a spacer frame 27 arranged between the glass sheets 6, which connects the two glass sheets 6 to one another in the glass sheet edge area, a primary seal (not shown) and an edge seal (secondary seal) 28. The glass sheets 6 and the spacer frame 27 define an pane inner space 29. The primary seal is present in a known manner between the spacer frame 27 and the respective glass sheet 6 and bonds them together.

The glass sheets 6 of the insulating glazing 26 can respectively be a single-pane glass sheet 22 or a laminated glass sheet 25.

The laser head 17 according to one aspect of the present disclosure (FIGS. 11-14) comprises a laser beam source 30 for providing or generating a laser beam 31, preferably a beam shaping device 32 for geometric beam shaping, preferably an energy distribution device 33 for adapting the energy distribution of the laser beam 31, according to the present disclosure an optical z-focus adjustment device 34 and preferably a scanning device 35.

The laser beam source 30 is preferably interchangeable, so that the optimum laser beam source 30 can be used for each application. Preferably, a laser beam source 30 suitable for the respective application in terms of wavelength and/or laser power and/or pulse duration is used.

Preferably, the laser beam source 30 is a UV laser or an IR laser or a VIS laser, depending on the method to be carried out.

Furthermore, it can be a continuous wave laser or a pulsed laser. Preferably, it is a pulsed laser in which the pulse duration and/or the repetition rate can be set within certain limits.

Preferably, the laser beam source 30 is also a fiber laser.

Preferably, the laser beam source 30 is also a laser in which the laser power can be adjusted. Preferably, the laser power is adjustable in the range from 5 to 1000 W, preferably 5 to 200 W, particularly preferably 20 to 200 W.

In a preferred embodiment, a pulsed ns fiber laser with a laser power of 100 W and a wavelength of 1 μm is used for laser modification, laser ablation and laser transfer printing.

As already explained, the laser head 17 also has the beam shaping device 32. The beam shaping device 32 is arranged downstream of the laser beam source 30 and is used for geometric beam shaping of the laser beam 31. Downstream in the sense of the application is to be understood in the direction of the laser beam 31.

For example, the beam shaping device 32 is used to shape the laser beam 31 in such a way that it has a rectangular cross-section or a linear cross-section or a circular cross-section. For this purpose, the beam shaping device 32 has, for example, a lens system, preferably a GRIN optics (gradient-index lens optics), in a manner known per se.

Furthermore, the beam shaping device 32 can preferably be brought into the beam path of the laser beam 31 and removed from it. Preferably, the beam shaping device 32 can be swiveled into the beam path and swiveled out again. The beam shaping device 32 is mounted in the laser head 17 appropriately for this purpose. Preferably, the laser head 17 also comprises corresponding drive means with which the beam shaping device 32 can be driven so as to be brought into the beam path and be removed therefrom.

As a result, the beam shaping device 32 can be arranged or positioned inside or outside the beam path of the laser beam 31, depending on the method to be performed and the required cross-sectional profile of the laser beam 31.

The beam shaping device 32 is also preferably interchangeable, so that the beam geometry to be generated can be varied.

In addition, several beam shaping devices 32 can also be provided, which can be selectively brought into and removed from the beam path. This can preferably be done by means of a turret, in particular one driven by an electric motor.

As already explained, the laser head 17 also has the energy distribution device or beam profile shaping device 33. The energy distribution device 33 is preferably arranged downstream of the geometric beam shaping device 32 and is used to adapt the energy distribution or to shape the beam profile of the laser beam 31. The energy distribution device 33 preferably has means for generating an annular beam profile (M profile) or a top-hat profile, generally from a Gaussian beam profile.

Analogous to the beam shaping device 32, the energy distribution device 33 can also be arranged or positioned inside or outside the beam path of the laser beam 31, depending on the process to be carried out and the required cross-sectional profile of the laser beam 31, for which purpose corresponding adjusting means are provided.

The energy distribution device 33 is also preferably interchangeable, so that the energy distribution to be generated can be varied.

In addition, there may also be several energy distribution devices 33 that can be selectively brought into and removed from the beam path. This can preferably be done by means of a turret, in particular one driven by an electric motor.

The energy distribution device 33 and the beam shaping device 32 can also be combined in one device.

As already explained, according to one aspect of the present disclosure, the laser head 17 also has the optical z-focus adjustment device 34. The optical z-focus adjustment device 34 is preferably arranged downstream of the energy distribution device 33 and is used for the, preferably automated, optical adjustment of the laser focus 31a along an optical z-axis 17a of the laser head 17 or for the optical displacement of the focal position of the laser focus 31a along the optical z-axis 17a. For this purpose, the z focus adjustment device 34 has an optical system, preferably a lens system.

The shifting of the laser focus 31a is also carried out in particular on the basis of the measurement results of the distance measuring device 49. The distance measuring device 49 is used to measure the glass sheet 6 to be processed in the z-direction. For this purpose, the distance measuring device 49 preferably has a measuring device laser beam source for generating a measuring laser beam and a laser beam detector, preferably a line sensor, for detecting laser beam reflections of the measuring laser beam.

By means of the distance measuring device 49, the glass sheet 6 to be processed or at least the area of the glass sheet 6 to be processed is irradiated by means of the measuring laser beam, whereby the measuring laser beam forms an angle with the surface normal to the glass sheet surfaces 6a;b. The measuring laser beam is reflected by the glass sheet surfaces 6a;b or the glass pane surfaces 22a;b and the reflected laser beam reflections are detected by the laser beam detector.

Preferably, the measuring laser beam is also linear, for which purpose the distance measuring device 49 has means known per se for shaping the measuring laser beam.

This measuring principle is known in particular from DE 10 2006 049 946 A1, to the content of which reference is hereby made.

With this measuring principle, a laser beam reflection is generated on each glass pane surface 22a;b, so that two reflections of the incident laser beam occur for each individual glass pane 22, namely on the one hand on the front glass pane surface 22a in the direction of incidence and, after passing through the glass pane 22, also on the rear glass pane surface 22b. Two laser beam reflections are therefore detected in the laser beam detector for each individual glass pane 22 after the incident laser beam reflections.

The position of the respective reflective glass pane surfaces 22a;b; is then determined from the number and type of reflections and the glass sheet 6 or the entire insulating glazing is thereby measured in the z-direction. In particular, the distances between the glass pane surfaces 22a;b are determined and their exact position in the z-direction is seen. This is important for the exact positioning of the laser focus 31a in the z-direction.

This is because it is important to focus the laser beam 31 on the correct plane depending on the method to be carried out. For example, the laser beam 31 must be focused on the inner or outer glass sheet surface 6a;b, the glass sheet coating 23 or the intermediate plastic layer 24, which will be discussed in more detail below. In addition, the focus may have to be adjusted parallel to the optical z-axis 17 extending in the z-direction during processing of the glass sheet 6 due to unevenness of the glass sheet surface 6a.

The number of reflections can also be used to determine the number of glass panes 22 arranged one behind the other if this is not known.

The distance measuring device 49 is preferably connected to the control device 4, which processes the measurement data. Alternatively, the distance measuring device can also have means for processing the measurement data.

As already explained, the laser head 17 also comprises the scanning device 35. The scanning device 35 is preferably arranged downstream of the optical z-focus adjustment device 34 and is used to move the laser beam 31 in a scan field. The scanning device 35 can be used to move the laser beam 31 in the y-direction and in the x-direction. For this purpose, the scanning device 35 has a scanning optics in a manner known per se. Preferably, the scanning optics is at least two adjustable mirrors. The scanning field is, for example, 100 mm×100 mm.

In a manner known per se, the laser beam 31 can be moved in the y-direction and in the x-direction in such a way that it remains parallel to the optical z-axis 17a or is deflected in relation to it.

The scanning device 35 also comprises an objective 47. The objective 47 preferably is short focal length. It preferably has a focal length of 20 to 200 mm, preferably 80 to 160 mm. Thereby a strong focusing and a small extension of the laser focus 31a into the depth or in the direction of the optical z-axis 17a is achieved. In particular, the laser focus 31a is constant in the range of approx. +/−1 mm in depth. This ensures that, for example, in a laminated glass sheet 25 or an insulating glazing 26, only the layer 23;24 to be processed is modified or ablated by means of the laser energy and the other areas of the glass sheet 6 remain unchanged.

Preferably, the objective 47 is also interchangeable, so that, among other things, the working distance can be varied and adapted. Preferably, the objective 47 can be unscrewed.

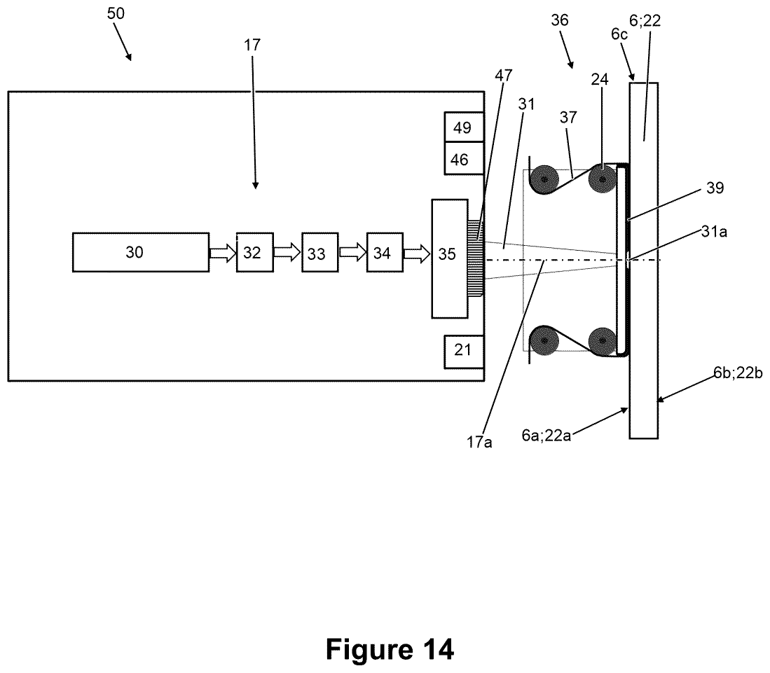

As already explained, the laser device 1 according to the invention is also used to coat a glass sheet surface 6a of the glass sheet 6 by means of laser transfer printing (FIG. 14). For this purpose, the laser head 17 has a laser transfer printing device 36.

The laser transfer printing device 36 has a, preferably tape-shaped, dispenser or carrier medium 37, in particular a tape-shaped carrier film, several guide rollers 38 and a pressure frame 39.

Furthermore, the laser transfer printing device 36 can preferably be brought into the beam path of the laser beam 31 and removed from it. Preferably, the laser transfer printing device 36 can be swiveled into the beam path and swiveled out again. The laser transfer printing device 36 is mounted accordingly for this purpose. Preferably, the laser head 17 also has corresponding drive means with which the laser transfer printing device 36 is connected in a drivable manner such that it can be brought into the beam path and removed therefrom.

However, the laser transfer printing device 36 can also be interchangeable or can be inserted into the laser head 17 only when required.

The dispenser or carrier medium 37 is preferably a coated plastic film, preferably made of PET. The carrier medium 37 is preferably tape-shaped.

Furthermore, the carrier medium 37 has a superficial carrier medium coating of coating material. The carrier medium coating preferably has at least one metallic layer and/or at least one ceramic layer, preferably a metal oxide layer.

The carrier medium coating is preferably single-layer. It particularly preferably consists of a metallic material, especially silver, copper or gold.

However, the carrier medium coating can also be a Low-E coating.

Furthermore, the carrier medium coating preferably comprises a thickness of <5 μm.

Furthermore, the carrier medium 37 is preferably interchangeable. This means that different carrier media with different carrier medium coatings can be used depending on the application.

The pressure frame 39 is used to press the tape-shaped carrier medium 37 onto the glass sheet 6 to be marked. The pressure frame 39 is preferably permeable to the laser radiation. Alternatively, the pressure frame 39 has an opening that exposes the area of the glass sheet 6 to be coated.

The tape-shaped carrier medium 37 is also guided around the rotatably drivable guide rollers 38 and is moved by these, if desired, relative to the laser beam 31 and the pressure frame 39. To drive the guide rollers 38 around their roller axis, the laser head 17 has corresponding drive means.

The laser unit 50 also preferably has an x-y measuring device 46, preferably a camera, for measuring the outer dimensions of the glass sheet 6 to be processed in the x and y directions, in particular for measuring the glass edge 6c in the x and y directions. For this purpose, the camera preferably has image recognition software known per se.

Furthermore, the laser unit 50 preferably has extraction suction device 21 for sucking material removed by the laser radiation.

All components of the laser unit 50 are preferably mounted on a base plate of the laser unit 50.

As already explained, the laser device 1 according to another aspect of the present disclosure also has the control device 4 for selecting and automatically controlling the various processing methods. For this purpose, the control device 4 has a program for controlling the respective processing method.

Preferably, the control unit 4 is mounted on the transport and positioning rack 3. The control device 4 also preferably has an operating or input panel 42 for operation by an operator 43.

The laser safety device 5 has a laser protection element 40, preferably a laser protection curtain 41, and a detection device for detecting the presence of the laser protection element 40. In particular, the detection device is configured to detect whether the laser protection element 40, preferably the laser protection curtain 41, is present and correctly positioned on the side of the glass sheet 6 opposite the laser head 17. For this purpose, the detection device has several sensors, preferably magnetic sensors and/or radio sensors. In addition, the detection device is in communication with the control device 4. Preferably, the control device 4 is configured so that the laser beam source 30 can only be started up and/or operated if the detection device detects correct positioning of the laser protection element 40, preferably the laser protection curtain 41. In particular, the control device 4 is set up so that the laser beam source 30 is automatically switched off if the laser protection element 40 is no longer properly positioned.

The laser protection element 40, preferably the laser protection curtain 41, also has fastening means for fastening to the respective object, e.g. a train inner skin 44b, which will be discussed in more detail below. The fastening means are preferably suction cups, in particular vacuum suction cups, or magnetic fastening means.

The laser device 1 according to one aspect of the present disclosure is supplied with energy either via a connection to a fixed power supply or the laser device 1 is self-sufficient and has its own energy supply device (not shown). The own energy supply device is preferably a generator or a battery. The generator is preferably mechanically decoupled from the transport and positioning rack 3 in order to avoid vibrations of the transport and positioning rack 3 during lasing.

The supply of compressed air of the laser device 1 according to the present disclosure is also provided either via the connection to a stationary compressed air source or the laser device 1 is self-sufficient and has its own compressed air source (not shown). The compressed air source is preferably used to operate the vacuum suction cups and/or to press the pressure frame 39 during laser transfer printing.

According to another aspect of the present disclosure, different processing methods can be carried out with the mobile laser device 1 according to the disclosure as described above.

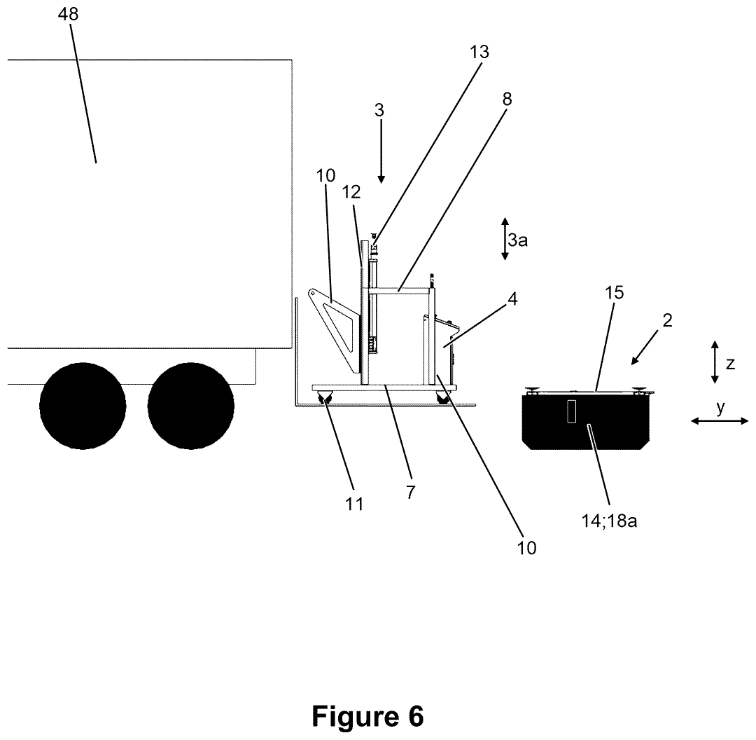

For this purpose, the mobile laser device 1 according to the present disclosure is first transported to the object to be processed or the place of use. This can be done, for example, in a van 48 (FIG. 6). For transport, the laser device 1 is preferably disassembled, preferably into three parts, namely the transport and positioning rack 3, the laser gantry 2 and the laser safety device 5. At the place of use, the laser device 1 is then assembled, in particular the laser gantry 2 is mounted on the transport and positioning rack 3. If necessary, the mobile laser device 1 is also connected to the external power supply device and/or the external compressed air source.

At the place of use, the assembled laser device 1 is then moved to the glass sheet 6 to be processed by means of the transport and positioning rack 3.

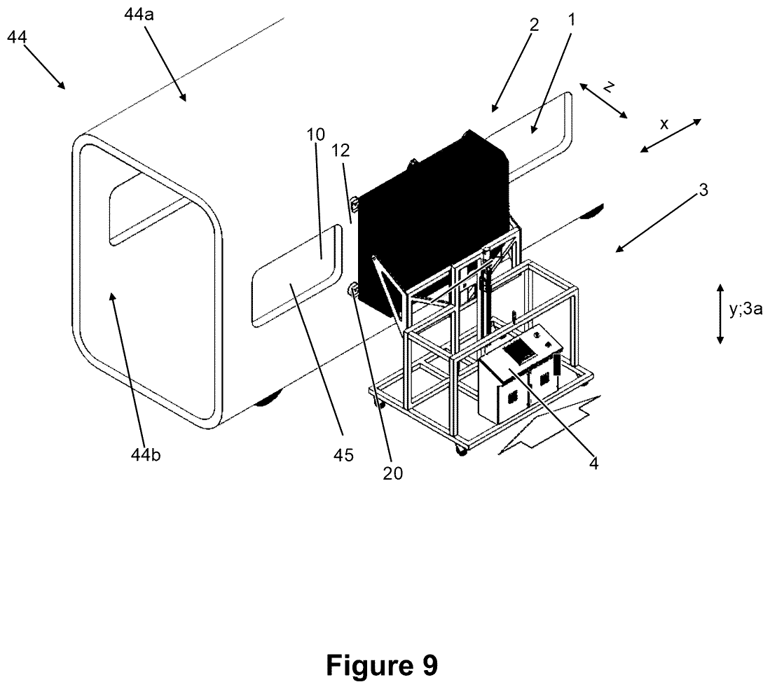

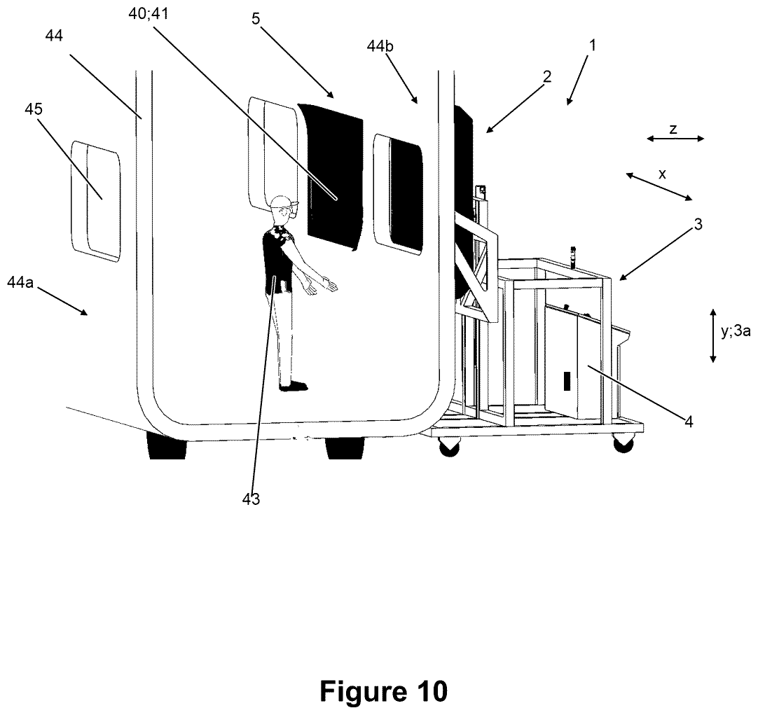

According to an embodiment of the present disclosure (FIGS. 9, 10), this is a glass sheet 6 of a train window 45 of a train 44.

Preferably, however, it can also be an installed glass sheet 6 of a building (=architectural glass), in particular of an office building, preferably of a window, or of a balustrade or of a balcony of the building or a façade panel of the building.

The laser device 1 is positioned relative to the object, for example by the operator 43, using the transport and positioning rack 3 and, if necessary, the laser gantry 2 is swiveled around the laser gantry rotation axis 2a.

After that, the laser gantry 2 is attached by means of the suction cups 20 to the object comprising the glass sheet 6 to be processed in a detachable but non-displaceable and non-rotatable manner. For example, the laser gantry 2 is attached to an outer skin 44a of the train 44. However, it can of course also be attached directly to the glass sheet 6.

The laser gantry 2 is arranged in such a way that it surrounds the train window 45 or the glass sheet 6.

In addition, the laser protection element 40 is positioned on the side of the glass sheet 6 opposite the laser gantry 2. For example, the laser protection element 40, preferably the laser protection curtain 41, is attached to the inner skin 44b of the train in such a way that it covers the train window 45 from the inside (FIG. 10). The detection device automatically detects the presence and correct positioning of the laser protection element 40 and sends corresponding information to the control device 4.

After that, preferably, the outer dimensions of the glass sheet 6 to be processed are measured in the x and y directions. For this purpose, the laser head 17 is moved over the glass sheet 6 in the x and y directions and a 2D image of the glass sheet 6 is preferably created using the x-y measuring device 46, preferably the camera. In particular, the x and y coordinates of the outer dimensions of the glass sheet 6 are determined. This information is particularly important for precise x/y positioning of the laser beam 31 in relation to the glass sheet 6 during the laser process.

The x-y measuring device 46, preferably the camera, is therefore in communication with the control device 4 and transmits the coordinates or the generated 2D image to it.

As already explained, the laser focus 31a must be positioned differently in the z-direction depending on the processing method to be carried out. For example, the laser beam 31 must be focused on the glass pane coating 23, the intermediate plastic layer 24, the interior of the glass sheet 6 or the glass sheet surface 6a;b or an interior glass pane surface 22a;b. Furthermore, in the case of a curved or uneven glass sheet 6, glass sheet surface 6a;b or glass pane surface 22a;b, the laser focus 31a must be readjusted accordingly during processing.

For this purpose, the glass sheet 6 is measured in the z-direction using the distance measuring device 49 as described above. This can take place during the measurement of the glass sheet 6 in the x/y direction, before or after.

Alternatively, the measurement in the z-direction can also be carried out online during the processing of the glass sheet 6, in that the distance measuring device 49 moves forwards in relation to the laser beam 31 and measures the area to be processed directly before it is processed with the laser beam 31. For this purpose, the distance measuring device 49 is mounted on the laser unit 50 such that it can be moved and driven in the x and y directions.

By means of the distance measuring device 49, in particular one or more curvatures or unevennesses of the glass sheet 6 and/or the glass sheet surface 6a;b or glass pane surface 22a;b and/or differences in thickness are also determined.

Based on the measurement results of the x-y measuring device 46, preferably the camera, and the distance measuring device 49, a 3D image of the glass sheet 6 to be processed is preferably created, in particular by the control device 4. The x- and y-coordinates are calculated on the basis of the x- and y-coordinates of the outer dimensions of the glass sheet 6 and the travel of the distance measuring device 49.

Before starting the processing step, the laser head 17 is then positioned accordingly in the x, y and z directions. To do this, the laser head 17 is moved along the guide rail 16 in the y-direction and/or moved with the guide rail along the guide beams 19a;b in the x-direction and/or moved in the z-direction relative to the guide rail 16 to the 0-position or start position.

Preferably, the laser focus 31a is initially focused on the glass sheet surface 6a facing the laser head 17 by positioning the laser head in the z-direction. Further focusing of the laser beam 31 then takes place via the optical z-focus adjustment device 34. In particular, the adjustment or displacement of the laser focus 31a along the optical z-axis 17a takes place during processing via the optical z-focus adjustment device 34. The adjustment or displacement is controlled automatically, preferably on the basis of the previously determined x, y and z coordinates, in particular the 3D image, of the glass sheet 6 or glass sheet surface(s) 6a;b or glass pane surface(s) 22a;b.

For processing, the laser head 17 is also moved in the x- and/or y-direction relative to the glass sheet 6 in a manner known per se and/or the laser beam 31 is moved in the x- and/or y-direction relative to the laser head 17 by means of the scanning device 35. Due to the additional movement of the laser beam 31 by means of the scanning device 35, the laser beam 31 can, for example, be split into several beams.

To move the laser head 17 in the y-direction, it is moved along the guide rail 16. To move the laser head 17 in the x-direction, it is moved together with the guide rail 16 along the guide beams 19a;b.

The laser head 17 can, for example, be moved step by step in a known manner (tile mode) or continuously.

As already explained, the laser device 1 according to the present disclosure has means for carrying out various processing methods:

### Laser Ablation of a Glass Pane Coating

According to one aspect of the present disclosure, the laser device 1 is used to at least partially ablate the superficial glass pane coating 23 of a glass sheet 6 by means of the laser beam 31 (laser ablation) (FIG. 11).

For this purpose, the laser beam 31 is focused on the glass pane coating 23. For example, the laser beam 31 is focused on the glass pane coating 23 of the inner glass sheet surface 6b of a glass sheet 6 of an insulating glazing 26. Individual or all layers of the glass pane coating 23 are completely removed, in particular vaporized or burnt, at least in certain areas by means of the laser beam 31.

If the glass sheet 6 has an additional protective coating of plastic, this can be removed beforehand, in particular mechanically or by means of laser radiation, or at the same time or together with the glass pane coating 23.

If necessary, the material removed by laser ablation is also sucked by means of the suction device 21. This is particularly the case if the processed glass sheet surface 6a;b is exposed or accessible from the outside.

For example, by laser ablation of the glass pane coating 23 a mobile radio permeable structure in the glass pane coating 23 in a glass sheet 6, preferably a glass sheet 6 of a train window 45, can be produced.

Furthermore, by laser ablation of the glass pane coating 23 a radar attenuating structure in the glass pane coating 23 in a glass pane 6, preferably a glass pane 6 of a train window 45, can be produced.

In particular, a bird protection structure can also be produced. This is an optical structure or an optical pattern that birds perceive as a clear obstacle. Preferably, a bird protection structure is generated in accordance with DE 10 2014 002 644 A1.

An electronic structure, e.g. an alarm loop or a switch or an electronic structure of a heating glass, can also be produced. Preferably, an electronic structure is generated according to WO 2020/079252 A2.

Furthermore, edge decoating of a glass sheet 6 can be performed. Preferably, edge decoating is carried out in accordance with DE 10 2018 107 697 A1. Here, the protective coating and/or the functional coating is removed by means of laser radiation. Alternatively, edge decoating is carried out in accordance with DE 10 2019 213 603 A1, whereby coating residues are removed by means of laser radiation.

Furthermore, a marking, preferably a machine-readable marking, preferably a machine-readable code, preferably a data matrix code (DCM) or a barcode or a QR code, can of course also be produced.

In addition, a facade element can be produced in accordance with DE 10 2014 014 889 A1.

### Laser Modification of a Glass Pane Coating

In addition, the laser device 1 according to another aspect of the present disclosure is used to modify the superficial glass pane coating 23 of a glass sheet 6 by means of the laser beam 31 (laser modification) (FIG. 12). During laser modification, individual or all layers of the glass pane coating 23 are changed (=modified) by means of the laser beam 31, at least in certain areas, in such a way that they are no longer electrically conductive, i.e. electrically insulating, and/or are discolored. Laser modification thus means changing or modifying the electrical and/or optical and/or mechanical properties of individual or all layers of the glass pane coating 23.

For this purpose, too, the laser beam 31 is focused on the glass pane coating 23, for example on the glass pane coating 23 of the inner glass sheet surface 6b of a glass sheet 6 of an insulating glazing 26.

If the glass pane coating 23 is only to be modified, the irradiation therefore takes place below the removal threshold. This means that no material is removed during modification. In particular, the composition of the glass pane coating 23 is chemically and/or physically changed during the modification. For example, the glass pane coating 23 may have layer(s) of atomic silver, which are changed under the influence of the laser beam 31 in such a way that the silver atoms agglomerate and form nanoparticles. As a result, the layer of atomic silver loses its electrical conductivity and becomes insulating. Preferably, the layer(s) of atomic silver are embedded in layers formed as protective layers, preferably electrically insulating layers, e.g. of metal oxide, in particular tin oxide.

The laser power and/or the wavelength of the laser beam 31 is thus adjusted depending on the desired result and depending on the layer(s) to be processed.

Laser modification can preferably be carried out in accordance with DE 10 2005 025 982 A1.

If the glass sheet 6 has a known protective coating made of plastic over the glass pane coating 23 prior to laser modification, the protective coating can be removed prior to laser modification, for example by means of laser radiation and/or mechanically. Or the protective coating is removed during the laser modification by the laser radiation by being ablated, preferably burnt, by the laser radiation. In particular, the laser modification is carried out in the same way as described in DE 10 2018 207 181 A1.

For example, by laser modification of the glass pane coating 23 a mobile radio-permeable structure in the glass pane coating 23 in a glass sheet 6, preferably a glass sheet 6 of a train window 45, can be produced.

Furthermore, by laser modification of the glass pane coating 23 a radar attenuating structure in the glass pane coating 23 in a glass pane 6, preferably a glass pane 6 of a train window 45, can be produced.

In particular, a bird protection structure can also be produced using laser modification. Preferably, a bird protection structure is produced in accordance with DE 10 2014 002 644 A1.

An electronic structure, e.g. an alarm loop or a switch or an electronic structure of a heating glass, can also be produced. Preferably, an electronic structure is produced in accordance with WO 2020/079252 A2.

Furthermore, a marking, preferably a machine-readable marking, preferably a machine-readable code, preferably a data matrix code (DCM) or a barcode or a QR code, can of course also be produced.

Decorative elements can also be produced.

### Laser Transfer Printing

In addition, the laser device 1 according to the present disclosure is used to coat a glass sheet surface 6a of the glass sheet 6 by means of laser transfer printing (FIG. 14). For example, an electronic structure or a colored structure, in particular a colored marking, is applied by means of laser transfer printing.

The structure is created by applying a coating material, preferably electrically conductive, to the glass sheet surface 6a by means of the laser transfer printing device 36. The glass sheet surface 6a is thus coated with the coating material.

For coating, the carrier medium 37 is pressed with its coated side against the glass sheet surface 6a of the glass sheet 6 to be coated by means of the pressure frame 39. This presses the carrier medium coating onto the glass sheet 6. Then, by means of the laser beam 31 focused on the carrier medium coating, coating material is transferred from the carrier medium coating to the glass sheet 6 and fixed to it. As the laser beam is absorbed by the coating material, it is released from the carrier medium 37 and transferred to the glass sheet surface 6a to be coated.

The carrier medium 37 can be moved relative to the laser beam 31 by means of the guide rollers 38 in such a way that the laser beam 31 always strikes coated carrier medium 37 or the carrier medium coating and not areas in which the carrier medium coating has already been (partially) removed. Alternatively or additionally, the laser beam 31 can be moved relative to the carrier medium 37 in the x and/or y direction. The movement of the laser beam 31 in the x- and/or y-direction relative to the carrier medium 37 is preferably performed by means of the scanning device 35. This is known per se.

In the event that there is no protective coating of plastic on the glass sheet surface 6a, the structure is preferably applied according to the method according to DE 10 2005 026 038 A1 or DE 10 2011 085 714 A1.

In the event that a protective coating is provided on the glass sheet surface 6a, the structure is preferably applied using the method according to DE 10 2018 207 181 A1. This means that the protective coating is removed by means of laser radiation, preferably burnt or burnt away, and in the same operation, coating material is applied by means of the laser radiation from the dispenser or carrier medium 37 to an exposed surface of the glass sheet 6, in particular printed on the surface, which surface was previously located underneath the protective coating of the glass sheet 6. In the process, the carrier medium 37, which has the superficial carrier medium coating of the coating material, is brought into contact with the protective coating of the glass sheet 6 with its coated side in the area to be coated. The protective coating is then removed by means of the laser radiation and, as described, the carrier medium coating material is transferred from the carrier medium coating to the glass sheet surface 6a and fixed to it.

In addition, the structure can also be applied to a coated glass sheet surface 6a;b using laser transfer printing. For example, the structure can be applied to the glass pane coating 23.

Laser transfer printing can be used in particular to create a bird protection structure. Preferably, a bird protection structure is produced in accordance with DE 10 2014 002 644 A1.

An electronic structure, e.g. an alarm loop or a switch or an electronic structure of a heating glass, can also be created. In particular, conductive paths can be applied.

Furthermore, a marking, preferably a machine-readable marking, preferably a machine-readable code, preferably a data matrix code (DCM) or a barcode or a QR code, can of course also be applied.

Decorative elements and frames can also be applied.

In addition, a biocidal glass sheet surface 6a;b according to DE 10 2016 125 544 A1 can also be produced.

### Combination of the Processing Methods

The aforementioned methods can also be combined with each other as desired and the structure can be produced by a combination of one or more of the methods described above. For example, the glass pane coating 23 can be removed and/or modified and a further structure can be applied to it by means of laser transfer printing.

### Laser Treatment of a Plastic Interlayer of a Laminated Glass Sheet

In addition, the laser device 1 according to the present disclosure is preferably used to modify the intermediate plastic layer 24 of a laminated glass sheet 25 by means of the laser beam 31 or to burn it (FIG. 13). In particular, the optical and/or mechanical properties of the plastic interlayer 24 are modified during modification. In particular, it is discolored.

Preferably, however, the intermediate plastic layer 24 is burnt.

For laser treatment, the laser beam 31 is focused on the plastic intermediate layer 24, i.e. between the two glass panes 22.

Laser treatment of the intermediate plastic layer 24 can also be used to produce a marking or decorative element.

In addition, an emergency exit window can be produced that can be removed.

### Create and/or Delete an Internal Marking or Surface Marking

In addition, the laser device 1 according to the present disclosure can also be used for laser-induced generation of an internal marking in the glass sheet 6, preferably by forming color centers, preferably by means of ultrashort pulsed laser radiation. For this purpose, a different laser beam source 30 must be used than in the methods described above.

In addition, the laser device 1 according to the present disclosure can also be used for laser-induced production of a surface marking on a glass sheet surface 6a or glass pane surface 22a;b by laser engraving, preferably by means of ultrashort pulsed laser radiation. In laser engraving, the glass sheet 6 or glass to be marked is ablated on the glass sheet surface 6a;b or glass pane surface 22a;b to be marked by means of laser radiation.

In addition, the laser device 1 according to the present disclosure can also be used to delete the marking by means of laser radiation.

Preferably, the marking and/or deletion of the marking can be carried out as described in DE 10 2020 215 234 A1 or DE 10 2020 215 235 A1.

The advantage of the mobile laser device 1 according to the present disclosure is that it can be used flexibly for different processing methods and at different places of use. It is also easy to transport and can therefore be used to process glass sheets 6 that have already been installed. As already explained, glass sheets 6 of a train window 45 or a window in office buildings can be processed in the installed state.

Due to the distance measuring device 49 and the optical z-focus adjustment device 34, glass sheets 6 that have already been installed can also be processed precisely and the different processing methods can be carried out with a different focus position in some cases. The mobile laser device 1 according to the present disclosure can therefore be used very flexibly.

Laser device 1 can also be quickly and easily converted thanks to the numerous interchangeable components.

Of course, it is also within the scope of the present disclosure that the laser gantry 2 is decoupled from the transport and positioning rack 3 during processing of the glass sheet 6. The transport and positioning rack 3 can also be omitted completely and the mobile laser device 1 can be transported to the glass sheet 6 to be processed by other means of transport, e.g. by means of a drone. In addition, the transport and positioning rack 3 does not have to be rollable, but can also be moved by means of an air cushion track.

In addition, the control device 4 does not have to be mounted on the transport and positioning rack 3. It is only important that the control device 4 is connected to the respective parts or components of the laser gantry 2, in particular the laser head 17 and the drive means for driving the laser head 17 in the x, y and z directions, in such a way as to control them. The connection can be wired or, if this is not the case, a radio connection, for example. For this purpose, the respective parts or components have corresponding receivers.

It is also within the scope of the present disclosure that the laser base unit 50 has several laser heads 17, preferably two laser heads 17.

The laser base unit 50 can also have several, preferably two, distance measuring devices 49.

Furthermore, it is also within the scope of the present disclosure that only the glass sheet surface 6a facing the laser head 17 is measured in the z-direction if the structure of the glass sheet 6 in the thickness direction, i.e. in particular the thickness of the glass sheet 6 and/or the individual glass panes 22 and the intermediate plastic layer 24, are known. This is because their position in the z-direction can then be calculated.

In conclusion, it is pointed out that all the above-mentioned, in particular claimed, features of the laser device and of the processing methods and of the uses are particularly advantageous in themselves and in any combination and are the subject of the present invention.

In addition, the respective upper and lower limits of the individual range specifications can all be combined with each other according to the invention.

1. A mobile laser device for processing glass sheets installed in an object, preferably a vehicle, more preferably a train, or a structure work, preferably a building, and comprising at least one glass pane, by means of laser radiation at different places of use, having a laser gantry with
a) a gantry base frame,
b) a laser unit movable back and forth on the gantry base frame in an x, y and z direction of the laser gantry relative to the gantry base frame, having a laser head with a, preferably interchangeable, laser radiation source for providing a laser beam,
c) preferably a laser protection bonnet covering the laser unit to protect the environment from laser radiation,
and
d) Fastening means for fixed but detachable attachment of the laser gantry to the object,
wherein the laser unit comprises a distance measuring device for measuring the glass sheet to be processed in the z-direction, and the laser head comprises an optical z-focus adjustment device for the, preferably automated, displacement of a laser focus of the laser beam along an optical z-axis of the laser head, in particular during the processing of the glass sheet.

2. The mobile laser device according to claim 1, characterized in that the distance measuring device comprises a measuring device laser beam source for generating a measuring laser beam and a laser beam detector, preferably a line sensor, for detecting laser beam reflections of the measuring laser beam.

3. The mobile laser device according to claim 1, wherein the laser device comprises at least one, preferably at least two, of the following means:
a) Means for laser modification of a glass pane coating of a glass pane of glass sheets,
b) a laser transfer printing device for coating glass sheets, in particular a glass sheet surface, by means of laser transfer printing,
c) Means for laser ablation of the glass pane coating of a glass pane of glass sheets,
d) Means for laser treatment of a plastic interlayer of laminated glass sheets,
e) Means for laser engraving of a glass pane surface of a glass pane of glass sheets,
f) Means for producing an internal modification in glass sheets,
g) Means for producing an internal engraving in glass sheets,
h) Means for deleting the internal modification, and
i) Means for deleting the laser engraving of the glass pane surface.

4. The mobile laser device according to claim 3, wherein the laser device comprises means for selectively positioning the laser transfer printing device in the beam path or outside the beam path of the laser beam.

5. The mobile laser device according to claim 1, wherein the laser head (17) comprises a scanning device (35) for moving the laser beam (31) in a scanning field in the x and y directions, the scanning device (35) preferably having a scanning optics for moving the laser beam (31) in the scanning field.

6. The mobile laser device according to claim 5, wherein the scanning device is arranged downstream of the optical z-focus adjustment device.

7. The mobile laser device according to claim 1, wherein the laser head, preferably the scanning device, comprises a, preferably interchangeable, objective for focusing the laser beam, wherein the objective is preferably short focal length and more preferably comprises a focal length of 20 to 200 mm, particularly preferably of 80 to 160 mm.

8. The mobile laser device according to claim 1, wherein laser head comprises a beam shaping device for geometric beam shaping of the laser beam, wherein the laser head preferably comprises means for selective positioning of the beam shaping device in the beam path or outside the beam path of the laser beam.

9. The mobile laser device according to claim 1, wherein the laser head comprises an energy distribution device for adapting the energy distribution of the laser beam, the laser head preferably comprising means for selectively positioning the energy distribution device in the beam path or outside the beam path of the laser beam.

10. The mobile laser device according to claim 1, wherein the laser unit comprises an x-y measuring device, preferably a camera, for measuring the outer dimensions of the glass sheet to be processed, in particular for measuring a glass sheet edge, in the x and y directions of the laser gantry.

11. The mobile laser device according to claim 1, wherein the laser device comprises a control device for the, in particular automated, control of the respective processing method to be carried out and/or for processing of the measurement data of the distance measuring device.

12. The mobile laser device according to claim 11, wherein the control device is configured to control the optical z-focus adjustment device on the basis of the measurement results of the distance measuring device.

13. The mobile laser device according to claim 1, wherein the laser device comprises a laser safety device for arrangement on the side of the glass sheet opposite the laser gantry to protect the surroundings from laser radiation.

14. The mobile laser device according to claim 13, wherein the laser device comprises a control device for the, in particular automated, control of the respective processing method to be carried out and the laser safety device comprises a laser protection element, preferably a laser protection curtain, and a detection device for detecting the correct positioning of the laser protection element, the detection device being connected to the control device and the control device being configured in such a way that the laser radiation source can only be started up and/or operated if correct positioning of the laser protection element, preferably of the laser protection curtain, is detected by means of the detection device.

15. The mobile laser device according to claim 1, wherein the laser device comprises a transport and positioning rack for setting up and preferably moving the mobile laser device on an underground and the laser gantry is connected to the transport and positioning rack so as to be movable back and forth in a, in particular vertical, rack height direction, the laser device preferably having drive means with which the laser gantry is connected so as to be drivable back and forth in the rack height direction.

16. The mobile laser device according to claim 15, wherein the laser gantry is connected to the transport and positioning rack so as to be rotatable about a, preferably horizontal, laser gantry axis of rotation, wherein the laser device preferably comprises drive means with which the laser gantry is drivable connected so as to rotate back and forth about the laser gantry axis of rotation.

17. The mobile laser device according to claim 3, wherein the laser transfer printing device comprises a, preferably tape-shaped carrier medium, in particular a tape-shaped carrier film, with a carrier medium coating and a pressure frame for pressing the carrier medium onto the glass sheet to be marked.

18. The mobile laser device according to claim 17, wherein the laser transfer printing device comprises means, in particular a plurality of drivable guide rollers, for driving the carrier medium relative to the laser beam and/or to the pressure frame.

19. The mobile laser device according to claim 1, wherein the laser unit comprises a suction device for sucking material removed by means of the laser radiation.

20. (canceled)

21. (canceled)

22. A method for processing a glass sheet having at least one glass pane and being installed in an object, preferably in a structure work, more preferably in a building, or in a vehicle, preferably in a train, by means of laser radiation, wherein processing is carried out by means of a mobile laser device according to claim 1.

23. The method according to claim 22, wherein one of the following processing methods is carried out with the mobile laser device:
a) Laser modification of a glass pane coating of a glass pane of the glass sheet,
b) Coating the glass sheet, in particular a glass sheet surface, by means of laser transfer printing,
c) Laser ablation of a glass pane coating of a glass pane of the glass sheet,
d) Laser treatment of a plastic interlayer of a laminated glass sheet,
e) Laser engraving of a glass pane surface of a glass pane of the glass sheet,
f) Producing an internal modification in the glass sheet,
g) Producing an internal engraving in the glass sheet,
h) Deleting the interior modification, and
i) Deleting the laser engraving of the glass pane surface.

24. The method according to claim 23, wherein the glass pane coating comprises at least one metallic and/or at least one ceramic layer, preferably a metal oxide layer.

25. The mobile laser device according to claim 5, wherein the scanning device comprises a, preferably interchangeable, objective for focusing the laser beam, wherein the objective is preferably short focal length and more preferably comprises a focal length of 20 to 200 mm, particularly preferably of 80 to 160 mm.

26. The mobile laser device according to claim 10, wherein the laser device comprises a control device for processing of the measurement data of the x-y measuring device.

27. The mobile laser device according to claim 26, wherein the control device is configured to control the optical z-focus adjustment device on the basis of the measurement results of the distance measuring device and of the x-y measuring device.
